(19) United States
(12) Patent Application Publication
(10) Pub. No.: US 2025/0251971 A1
(43) Pub. Date: Aug. 7, 2025

(54) SERVICE DIFFERENTIATION IN PARTITIONED NEURAL NETWORK INFERENCE

(71) Applicant: Cisco Technology, Inc., San Jose, CA (US)

(72) Inventors: Myungjin Lee, Bellevue, WA (US); Ramana Rao V. R. Kompella, Foster City, CA (US)

(73) Assignee: Cisco Technology, Inc., San Jose, CA (US)

(21) Appl. No.: 18/435,436

(22) Filed: Feb. 7, 2024

(51) Int. Cl. G06F 9/48; G06N 3/063

(52) U.S. Cl. CPC G06F 9/4881; G06N 3/063

(57) ABSTRACT

In one implementation, a controller determines a level of service for a task request for processing by a partitioned neural network executed across a plurality of devices. The device identifies performance characteristics of different processing paths across the partitioned neural network. The device selects, based on the level of service for the task request and the performance characteristics of the different processing paths, a particular path from among the different processing paths to process the task request. The device sends the task request for processing by the partitioned neural network along the particular path.

### TECHNICAL FIELD

The present disclosure relates generally to computer networks, and, more particularly, to service differentiation in partitioned neural network inference.

### BACKGROUND

As machine learning/artificial intelligence techniques continue to evolve and mature, the number of use cases for these techniques also continue to increase. For instance, video analytics techniques are becoming increasingly ubiquitous as a complement to new and existing surveillance systems. In such deployments, neural network-based person detection and reidentification allows the system to track a specific person across different video feeds throughout a physical location. More advanced video analytics techniques also attempt to detect certain types of events. Beyond video analytics, other use cases for machine learning/artificial intelligence further range from sensor analytics to autonomous vehicles, to network security, to name a few.

While machine learning/artificial intelligence techniques such as neural networks are quite promising, the more capable the model, the more resource intensive the model is to execute. In cases in which the model is too large to execute on a singular device, the model could be partitioned into smaller pieces (e.g., by dividing its layers) for execution in a distributed manner. However, this is also typically done in an egalitarian manner with respect to the tasks, the data at hand, and even the requestors of the tasks. Consequently, processing a particular request using a partitioned and distributed model could negatively impact the performance of another, higher-priority request.

### BRIEF DESCRIPTION OF THE DRA WINGS

The implementations herein may be better understood by referring to the following description in conjunction with the accompanying drawings in which like reference numerals indicate identically or functionally similar elements, of which:

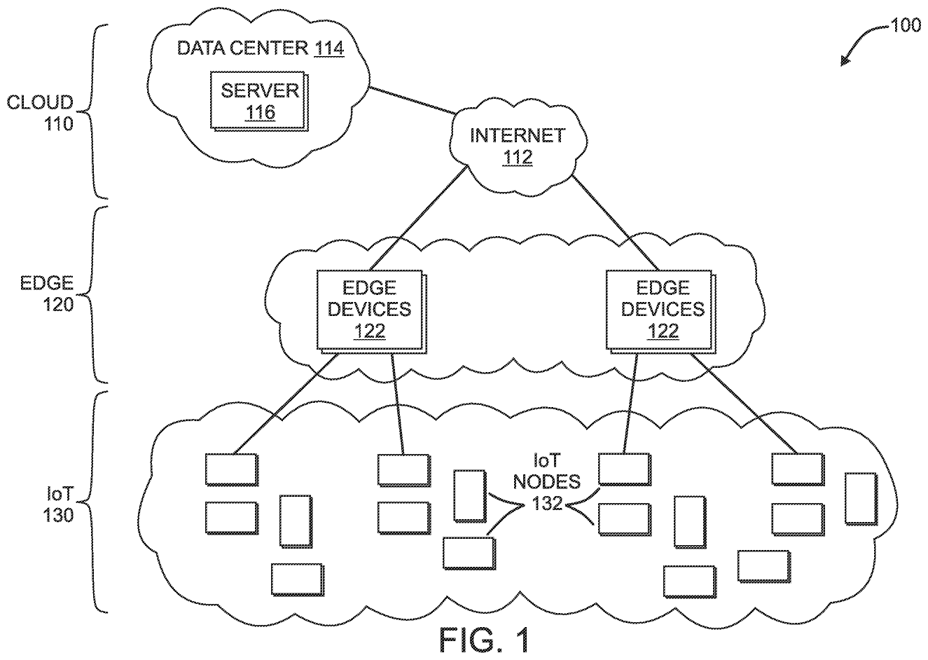

FIG. 1 illustrate an example network;

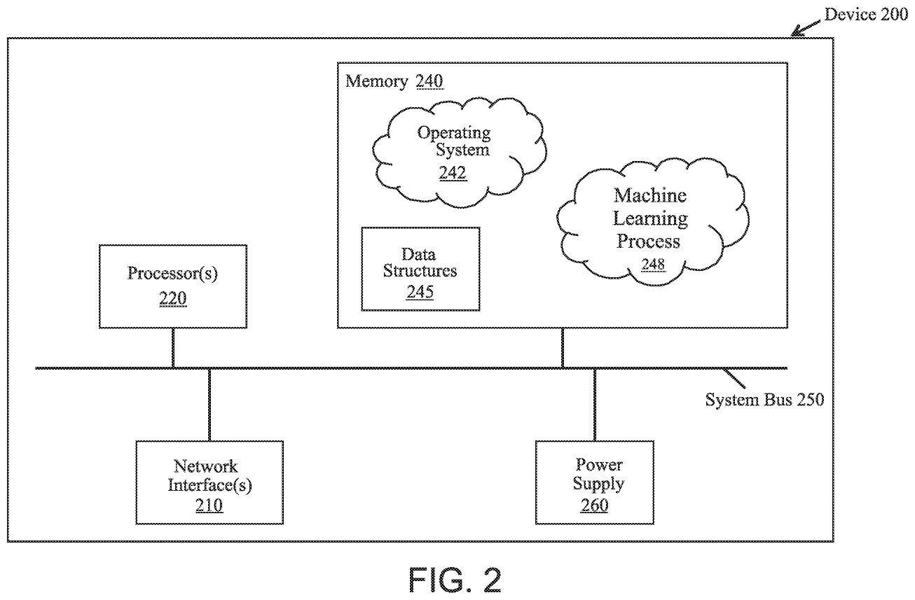

FIG. 2 illustrates an example network device/node;

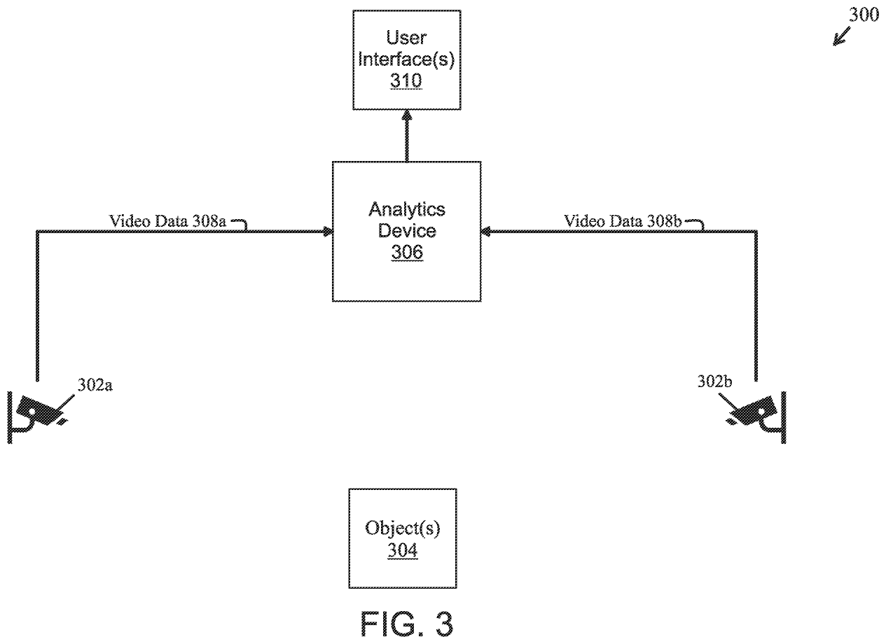

FIG. 3 illustrates an example system for performing video analytics;

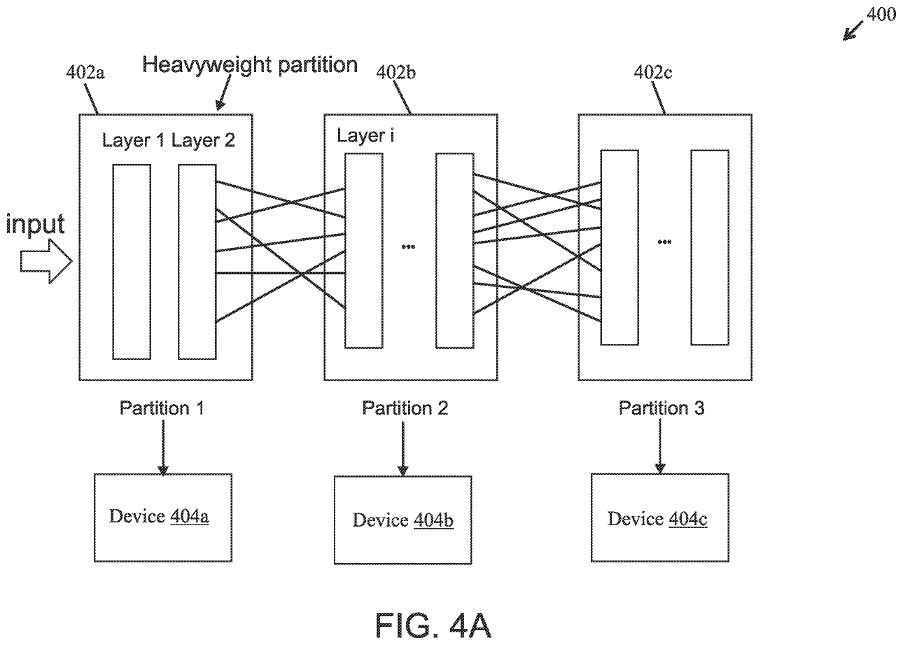

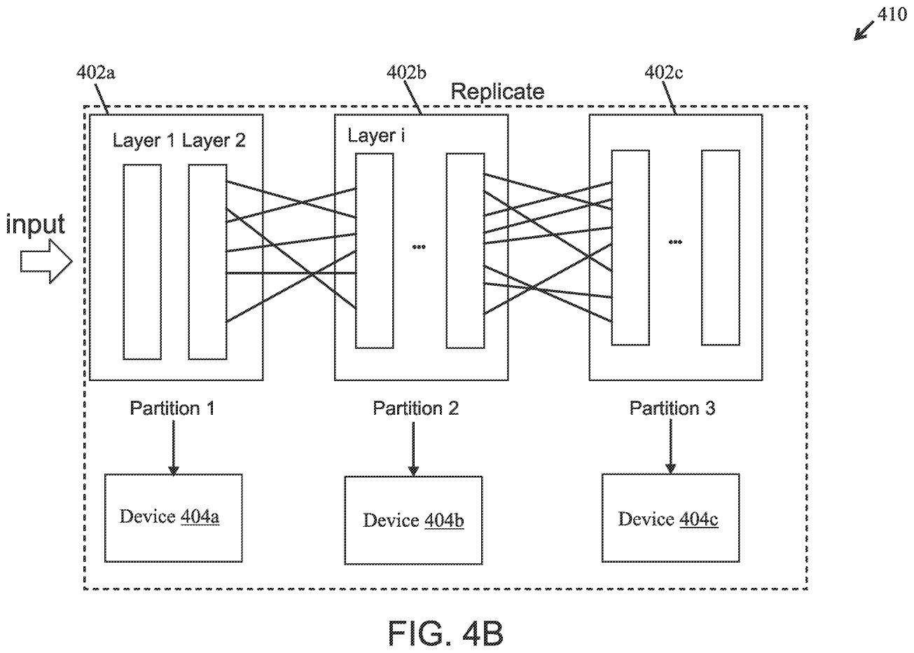

FIGS. 4A-4B illustrate an example of scaling a partitioned neural network;

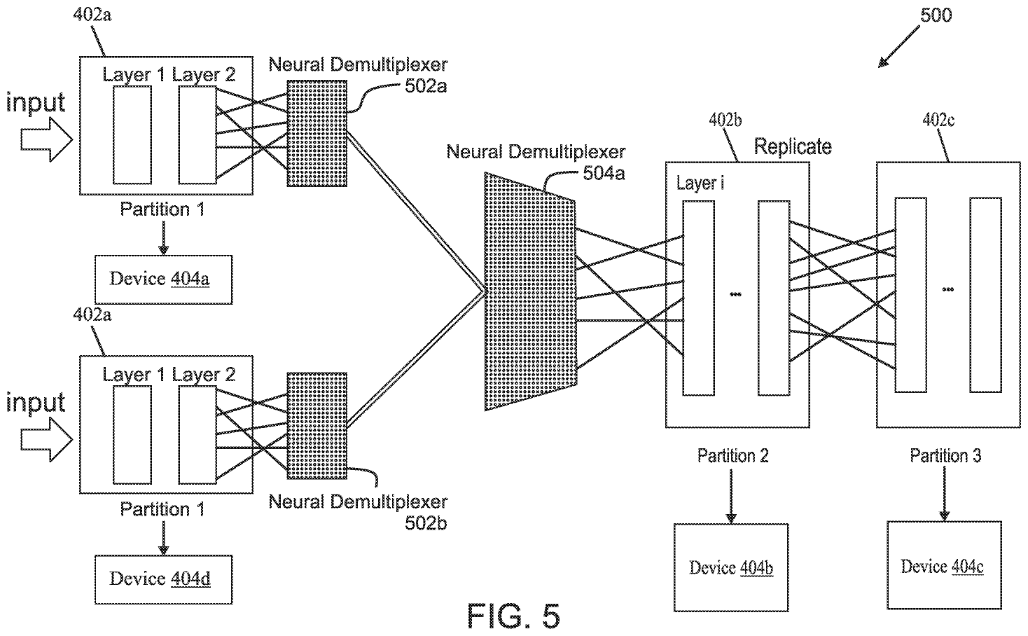

FIG. 5 illustrates an example of replicating a partition of a partitioned neural network;

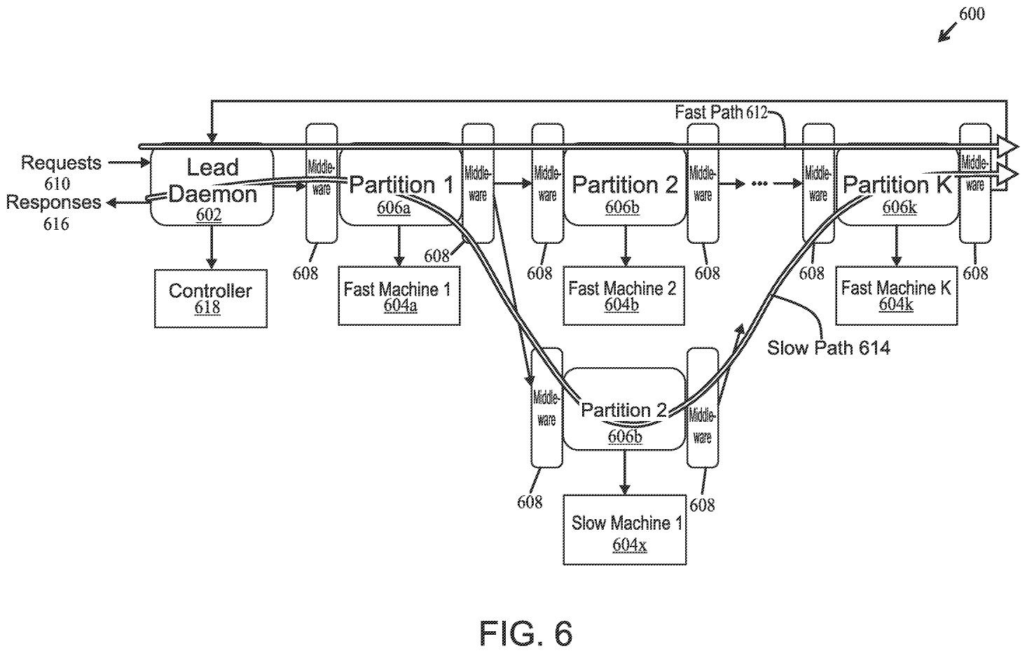

FIG. 6 illustrates an example of service differentiation in partitioned neural network inference; and

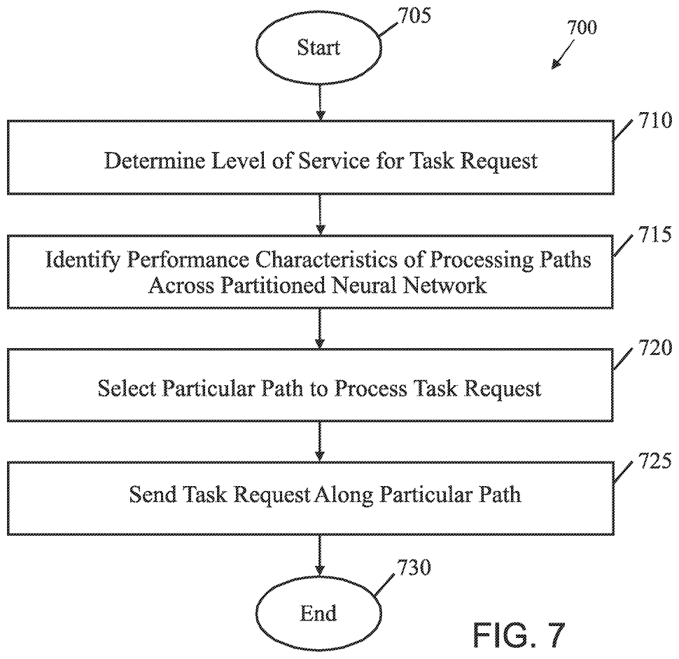

FIG. 7 illustrates an example simplified procedure for performing service differentiation in a partitioned neural network.

### DESCRIPTION OF EXAMPLE IMPLEMENTATIONS

### Overview

According to one or more implementations, a controller determines a level of service for a task request for processing by a partitioned neural network executed across a plurality of devices. The device identifies performance characteristics of different processing paths across the partitioned neural network. The device selects, based on the level of service for the task request and the performance characteristics of the different processing paths, a particular path from among the different processing paths to process the task request. The device sends the task request for processing by the partitioned neural network along the particular path.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. Other types of networks, such as field area networks (FANs), neighborhood area networks (NANs), personal area networks (PANs), etc. may also make up the components of any given computer network.

In various implementations, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or wired networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge computing, also sometimes referred to as “fog” computing, is a distributed approach of cloud implementation that acts as an intermediate layer from local networks (e.g., IoT networks) to the cloud (e.g., centralized and/or shared resources, as will be understood by those skilled in the art). That is, generally, edge computing entails using devices at the network edge to provide application services, including computation, networking, and storage, to the local nodes in the network, in contrast to cloud-based approaches that rely on remote data centers/cloud environments for the services. To this end, an edge node is a functional node that is deployed close to IoT endpoints to provide computing, storage, and networking resources and services. Multiple edge nodes organized or configured together form an edge compute system, to implement a particular solution. Edge nodes and edge systems can have the same or complementary capabilities, in various implementations. That is, each individual edge node does not have to implement the entire spectrum of capabilities. Instead, the edge capabilities may be distributed across multiple edge nodes and systems, which may collaborate to help each other to provide the desired services. In other words, an edge system can include any number of virtualized services and/or data stores that are spread across the distributed edge nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:
1) Links are generally lossy, such that a Packet Delivery Rate/Ratio (PDR) can dramatically vary due to various sources of interferences, e.g., considerably affecting the bit error rate (BER);
2) Links are generally low bandwidth, such that control plane traffic must generally be bounded and negligible compared to the low rate data traffic;
3) There are a number of use cases that require specifying a set of link and node metrics, some of them being dynamic, thus requiring specific smoothing functions to avoid routing instability, considerably draining bandwidth and energy;
4) Constraint-routing may be required by some applications, e.g., to establish routing paths that will avoid non-encrypted links, nodes running low on energy, etc.;
5) Scale of the networks may become very large, e.g., on the order of several thousands to millions of nodes; and
6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

FIG. 1 is a schematic block diagram of an example simplified computer network 100 illustratively comprising nodes/devices at various levels of the network, interconnected by various methods of communication. For instance, the links may be wired links or shared media (e.g., wireless links, wired links, etc.) where certain nodes, such as, e.g., routers, sensors, computers, etc., may be in communication with other devices, e.g., based on connectivity, distance, signal strength, current operational status, location, etc.

Specifically, as shown in the example IoT network 100, three illustrative layers are shown, namely cloud layer 110, edge layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the edge layer 120, various edge devices 122 may perform various data processing functions locally, as opposed to datacenter/cloud-based servers or on the endpoint IoT nodes 132 themselves of IoT device layer 130. For example, edge devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.), or other shared-media protocols where appropriate. In this context, a protocol consists of a set of rules defining how the nodes interact with each other.

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over links coupled to the network. The network interfaces 210 may be configured to transmit and/or receive data using a variety of different communication protocols, such as TCP/IP, UDP, etc. Note that the device 200 may have multiple different types of network connections, e.g., wireless and wired/physical connections, and that the view herein is merely for illustration.

The memory 240 comprises a plurality of storage locations that are addressable by the processor 220 and the network interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes/services may comprise an illustrative machine learning process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

In various implementations, machine learning process 248 may employ one or more supervised, unsupervised, or self-supervised machine learning models. Generally, supervised learning entails the use of a training set of data that is used to train the model to apply labels to the input data. For example, the training data may include sample video data depicting a particular event that has been labeled as such. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Self-supervised learning models take a middle ground approach that uses a greatly reduced set of labeled training data.

Example machine learning techniques that machine learning process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

In further implementations, machine learning process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, process 248 may use a generative model to generate synthetic network traffic based on existing user traffic to test how the network reacts. Example generative approaches can include, but are not limited to, generative adversarial networks (GANs), large language models (LLMs), other transformer models, and the like.

In further implementations, machine learning process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, network control process 248 may use a generative model to generate synthetic network traffic based on existing user traffic to test how the network reacts. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that assesses video data to identify a certain type of object or event. In such a case, the false positives of the model may refer to the number of times the model incorrectly flagged the video data as depicting the type of object or event. Conversely, the false negatives of the model may refer to the number of times the model incorrectly determined that the video data does not depict the type of object or event. True negatives and positives may refer to the number of times the model correctly identified the video as not depicting the object/event or depicting it, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

FIG. 3 illustrates an example system 300 for performing video analytics, as described in greater detail above. As shown, there may be any number of cameras 302 deployed to a physical area, such as cameras 302a-302b. Such surveillance is now fairly ubiquitous across various locations including, but not limited to, public transportation facilities (e.g., train stations, bus stations, airports, etc.), entertainment facilities (e.g., sports arenas, casinos, theaters, etc.), schools, office buildings, and the like. In addition, so-called “smart” cities are also now deploying surveillance systems for purposes of monitoring vehicular traffic, crime, and other public safety events.

Regardless of the deployment location, cameras 302a-302b may generate and send video data 308a-308b, respectively, to an analytics device 306 (e.g., a device 200 executing machine learning process 248 in FIG. 2). For instance, analytics device 306 may be an edge device (e.g., an edge device 122 in FIG. 1), a remote server (e.g., a server 116 in FIG. 1), or may even take the form of a particular endpoint in the network, such as a dedicated analytics device, a particular camera 302, or the lie.

In general, analytics device 306 may be configured to provide video data 308a-308b for display to one or more user interfaces 310, as well as to analyze the video data for events that may be of interest to a potential user. To this end, analytics device 306 may perform object detection on video data 308a-308b, to detect and track any number of objects 304 present in the physical area and depicted in the video data 308a-308b. In some implementations, analytics device 306 may also perform object re-identification on video data 308a-308b, allowing it to recognize an object 304 in video data 308a as being the same object in video data 308b or vice-versa.

As noted above, artificial intelligence/machine learning presents a wide variety of use cases, ranging from video analytics, to (semi-) autonomous vehicles, to network security, and beyond. One challenge, though, relates to the computational resources needed to execute large models. This is particularly true with respect to using a machine learning model to make inferences at a device with limited resources, such as an edge device (e.g., an edge device 122).

One way to help address the resource requirements of a neural network-based model would be to partition the neural network such that each partition includes one or more layers of the neural network and the partitions are executed in a distributed manner across a plurality of devices in a computer network. In such a setup, the first device in the chain inputs the input data to the first partition of the neural network and sends the resulting output data on to the next, downstream device and partition in the chain. This process repeats until the final device and partition is reached, in which case the output is the desired inference about the input data (e.g., a classification of the input data, etc.).

However, one observation herein is that different partitions of a partitioned neural network typically consume different amounts of computational resources. This can lead to the formation of computational bottlenecks across the partitioned neural network, increasing the amount of time needed for the full neural network to complete its inference tasks.

By way of example, FIG. 4A illustrates an example of a partitioned neural network 400. In order to better handle the resource requirements of partitioned neural network 400, the system may divide partitioned neural network 400 into a series of partitions, such as partitions 402a-402c shown. Here, partition 402a may include the first layer of partitioned neural network 400 (i.e., Layer 1) and may also include any number of subsequent/downstream layers, as well, such as Layer 2, etc. Similarly, partition 402b may include any number of downstream layers from that of partition 402a. Finally, partition 402c may include any number of layers of partitioned neural network 400 that are downstream from that of partition 402b. As would be appreciated, only three partitions are shown in FIG. 4A for purposes of simplicity and a neural network may be partitioned into any number of partitions, as desired.

To help address the resource costs associated with executing partitioned neural network 400, each of partitions 402a-402c may be deployed to a different device amongst a plurality of devices 404. For instance, device 404a may execute partition 402a and provide its output to device 404b via a computer network for input to partition 402b. In turn, device 404b may provide the output of partition 402b via the computer network to device 404c for input to partition 402c.

An observation herein is that the resources required to execute each of partitions 402a-402c may vary. For instance, as shown, partition 402a may be considered to be a ‘heavyweight’ partition, requiring more computational resources than that of partitions 402b-402c. Consequently, during execution of partitioned neural network 400, partition 402a could present a computational bottleneck, as any delays in completing its execution by device 404a will lead to greater delay in partitioned neural network 400 reaching its final inference.

In some instances, one approach to address any performance degradations of partitioned neural network 400 due to partition 402a acting as a bottleneck would be to replicate partitioned neural network 400, allowing multiple copies of partitioned neural network 400 to be executed in parallel. For instance, as shown in example 410 in FIG. 4B, partitions 402a-402c could be replicated and deployed to a new set of devices 404d-404f for execution, respectively. Thus, one copy of partitioned neural network 400 may be executed across devices 404a-404c, while a second copy of partitioned neural network 400 may be executed across devices 404d-404f.

While the above approach could help to improve the performance of the system, it should be noted that partition 402a is the true bottleneck for partitioned neural network 400 and that replicating partitions 402b-402c may itself be a waste of computational resources. Indeed, taking this approach effectively doubles the computational resources needed each time that partitioned neural network 400 is replicated.

FIG. 5 illustrates an example 500 of replicating a partition of a partitioned neural network, in various implementations. As shown, again consider the case of partitioned neural network 400 that has been partitioned into partitions 402a-402c, which partition 402a being the most resource intensive.

In various implementations, a controller for partitioned neural network 400, which may be any of devices 404a-404d shown, or another device in communication therewith, may receive performance data regarding the execution of partitioned neural network 400. For instance, such information may include, but is not limited to, latency/delay information, network path information between the devices 404a-404d, queue information, or the like. In addition, in some cases, the controller may also receive information regarding the used and/or available resources for each of devices 404a-404d.

Using the captured performance information, the controller may then flag one of the partitions as being a bottleneck. For instance, again assume that partition 402a is resource intensive and its execution by device 404a is slowing down the inference by the full partitioned neural network 400.

In various implementations, rather than simply replicating the entirety of partitioned neural network 400 for execution by additional devices, the controller may instead opt to replicate only the bottlenecked partition, partition 402a. Thus, as shown, the controller may configure device 404d to execute a replica of partition 402a. This means that there are now two options available with respect to the execution of partition 402a for any given set of input data (e.g., sensor data, other telemetry, etc.): 1.) let the original partition 402a on device 404a process it or 2.) let device 404d instead execute its replica of partition 402a.

In order to connect both partition 402a on device 404a and its replica partition 402a on device 404d to the downstream partition, partition 402b on device 404b, the controller may also configure device 404b to execute a neural multiplexer 504a. The role of neural multiplexer 504a is to take as input the output of either copy of partition 402a from either device 404a or device 404d, depending on which one was selected by the controller to process a given set of input data.

In addition, in some instances, the controller may also configure device 404a to execute a first neural demultiplexer 502a and device 404d to execute a second neural demultiplexer 502b. Each of demultiplexers 502-502b may be configured to take as input the output of its associated copy of partition 402a and provide it via the computer network to neural multiplexer 504a for input to the downstream partition 402b. From there, the chain of partitions 402a-402c will proceed as normal, with device 404b sending the output of partition 402b onward to device 404c for input to partition 402c.

### Service Differentiation in Partitioned Neural Network Inference

The techniques herein allow for differentiated services to be implemented in a partitioned artificial intelligence system in which an artificial intelligence/machine learning model (e.g., a neural network) is partitioned and executed across a plurality of devices. In some aspects, the techniques herein may determine the different levels of performance offered by different paths along the partitioned model. In turn, the system may send a given task request along a particular one of those paths, based on characteristic of the request such as its associated requestor, its type (e.g., the type of processing or inference being requested), a type of data associated with the request (e.g., audio, video, text, image, etc.), combinations thereof, or the like.

Illustratively, the techniques described herein may be performed by hardware, software, and/or firmware, such as in accordance with the machine learning process 248, which may include computer executable instructions executed by the processor 220 (or independent processor of interfaces 210), to perform functions relating to the techniques described herein.

Specifically, according to various implementations, a controller determines a level of service for a task request for processing by a partitioned neural network executed across a plurality of devices. The device identifies performance characteristics of different processing paths across the partitioned neural network. The device selects, based on the level of service for the task request and the performance characteristics of the different processing paths, a particular path from among the different processing paths to process the task request. The device sends the task request for processing by the partitioned neural network along the particular path.

Operationally, FIG. 6 illustrates an example 600 of service differentiation in partitioned neural network inference, according to various implementations. Continuing the examples above of a scalable partitioned neural network in which copies of a given partition may be executed by different devices, again assume that there is a partitioned neural network that includes k-number of partitions, such as a first partition 606a, a second partition 606b, etc., up to a kth partition 606k. Each of these partitions may be executed by a different device from among a plurality of devices interconnected by a computer network. For instance, partition 606a may be executed by device 604a, partition 606b may be executed by device 604b, partition 606k may be executed by device 604k, etc.

In accordance with the techniques above, a controller 618 for the partitioned system may scale the partitioned neural network up (or down) through use of middleware 608 executed by the devices 604 of the system. Such middleware 608 may include any number of multiplexers and corresponding demultiplexers, thereby allowing controller 618 to configure different devices 604 to execute copies of the same partition of the neural network. For instance, as shown, controller 618 may configure device 604b and device 604x to execute copies of partition 606 and configure the middleware 608 of device 604a, device 604b, and device 604x, to effectively form parallel processing paths within the partitioned neural network.

As would be appreciated, as copies of partitions 606 are configured for execution in the system by different devices, the resulting processing paths may offer different degrees of performance, such as latency, to process incoming task requests 610 and return corresponding responses 616. For instance, as shown, there may be a first processing path 612 whereby a request is sent across device 604a, device 604b, . . . , and device 604k, as well as a second path 614 that is sent across device 604a, device 604x, . . . , and device 604k. In many cases, path 612 and path 614 may offer different degrees of performance. For instance, as shown, assume that path 612 is a ‘fast’ path that has lower latency than that of path 614, which is considered to be a ‘slow’ path.

To assess the performances of the different processing paths in the partitioned neural network at any given time, controller 618 may collect performance characteristics that affect the overall performance of a path such as any or all of the following:
Queue information for a given device 604
The available resources of a given device 604 (e.g., memory, CPU, etc.)
Performance information for the computer networking path connecting devices 604 (e.g., network latency, packet loss, jitter, bandwidth, etc.)
Etc.

For instance, controller 618 may determine that path 614 is slower than path 612 because device 604b executing the first copy of partition 606b has more processing capabilities than that of device 604x executing the other copy of partition 606b. Indeed, this is very typical in deployments that include heterogeneous computing nodes, as available nodes/devices are added over time with different capabilities than existing nodes.

As noted above, a naïve approach to selecting which processing path should process a given request in requests 610 may be based on whichever copy of a partition 606 offers the best performance at any given time. For instance, since path 612 is faster than path 614, the system may simply send all requests 610 through device 604b until the situation changes. However, one observation herein is that different task requests 610 may have different requirements in terms of how they are processed, meaning that certain task requests could be processed along path 614 in an acceptable manner. This gives rise, then, to the possibility of the partitioned system offering differentiated services, depending on the needs of a given request 610.

In various implementations, controller 618 may execute a lead daemon 602 that first determines the level of service required for an incoming task request 610. To do so, daemon 602 may assess any or all of the following for a given task request 610:
The identity of the requestor associated with that request—for instance, certain requestors may have different levels of service (e.g., one requestor may have a free tier account, another may have a paid, ‘gold’ tier account, etc.).
The type of data associated with that request—for instance, video data may require a greater level of service than that of audio or text data, data captured from one location may require a greater level of service than that of another (e.g., video data captured in a sensitive area versus a public area), etc.
The type of task requested—for instance, certain types of tasks may be deemed more important than others, such as different types of inference or classification tasks.
Etc.

Based on the level of service that daemon 602 determines for a given request 610 and the performance characteristics of the different paths, it may select a particular processing path to process that request. In some instances, daemon 602 may do so upfront by adding a flag to the request 610 indicative of the selected path itself (e.g., a path identifier, etc.), and send the request along its selected path. In turn, the middleware 608 of the devices 604 along the selected path may forward the request to the next device 604 along the path. For instance, if the flag of a given request 610 indicates path 612, the middleware 608 of device 604a may send the request to device 604b for processing by its copy of instance of partition 606b, rather than that of device 604x.

In further implementations, daemon 602 may instead flag a given request 610 with information that allows middleware 608 to dynamically route that request according to the requirements associated with the flag. For instance, rather than daemon 602 indicating that a request 610 must traverse path 612, it may determine that the request requires processing by whatever the fastest path is at the time, allowing the middleware of 608 of each device processing the request to make forwarding decisions on the fly. In this case, controller 618 may still be seen as making the path selection decision through the forwarding, as it is still responsible for overseeing the sharing of the performance metrics among the devices 604 and configuring them. Additionally, controller 618 may also still be responsible for scaling up or down new copies of a partition, thereby influencing the path over which a given request 610 traverses.

FIG. 7 illustrates an example simplified procedure 700 (e.g., a method) for performing service differentiation in a partitioned neural network, in accordance with one or more implementations described herein. For example, a non-generic, specifically configured controller (e.g., device 200) may perform procedure 700 by executing stored instructions (e.g., machine learning process 248). The procedure 700 may start at step 705, and continues to step 710, where, as described in greater detail above, the controller may determine a level of service for a task request for processing by a partitioned neural network executed across a plurality of devices. In various implementations, the level of service is based on a type of request associated with the task request or a data type associated with the task request. In further implementations, the level of service is based on a requestor that issued the task request. In one instance, the task request requests that the partitioned neural network make an inference about sensor data included in the task request.

At step 715, as detailed above, the controller may identify performance characteristics of different processing paths across the partitioned neural network. For instance, the performance characteristics may be indicative of at least one of: path latencies of the different processing paths, latency metrics for the plurality of devices, or queue information for the plurality of devices. In various implementations, a first device in the plurality of devices executes a partition of the partitioned neural network and a second device in the plurality of devices executes a copy of that partition. In some instances, the first device is located along the particular path, and the second device is located along another path from among the different processing paths. In one implementation, the plurality of devices executes at least one multiplexer and demultiplexer that connect two or more partitions of the partitioned neural network.

At step 720, the controller may select, based on the level of service for the task request, a particular path from among the different processing paths to process the task request.

At step 725, as detailed above, the controller may send the task request for processing by the partitioned neural network along the particular path. In some implementations, the controller may do so by applying a label to the task request indicative of the level of service. In some cases, a device from among the plurality of devices prioritizes the task request for processing by a partition of the partitioned neural network based on the label.

Procedure 700 then Ends at Step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for service differentiation in partitioned neural network inference, it is to be understood that various other adaptations and modifications may be made within the spirit and scope of the implementations herein. For example, while certain implementations are described herein with respect to specific use cases for the techniques herein, the techniques can be extended without undue experimentation to other use cases, as well.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof, that cause a device to perform the techniques herein. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method comprising:
determining, by a controller, a level of service for a task request for processing by a partitioned neural network executed across a plurality of devices;
identifying, by the controller, performance characteristics of different processing paths across the partitioned neural network;
selecting, by the controller, a particular path from among the different processing paths to process the task request, based on the level of service for the task request and the performance characteristics of the different processing paths; and
sending, by the controller, the task request for processing by the partitioned neural network along the particular path.

2. The method as in claim 1, wherein a first device in the plurality of devices executes a partition of the partitioned neural network and a second device in the plurality of devices executes a copy of that partition.

3. The method as in claim 2, wherein the first device is located along the particular path and the second device is located along another path from among the different processing paths.

4. The method as in claim 1, wherein the level of service is based on a type of request associated with the task request or a data type associated with the task request.

5. The method as in claim 1, wherein the level of service is based on a requestor that issued the task request.

6. The method as in claim 1, wherein the plurality of devices executes at least one multiplexer and demultiplexer that connect two or more partitions of the partitioned neural network.

7. The method as in claim 1, wherein the performance characteristics are indicative of at least one of: path latencies of the different processing paths, latency metrics for the plurality of devices, or queue information for the plurality of devices.

8. The method as in claim 1, wherein sending the task request for processing by the partitioned neural network along the particular path comprises:
applying, by the controller, a label to the task request indicative of the level of service.

9. The method as in claim 8, wherein a device from among the plurality of devices prioritizes the task request for processing by a partition of the partitioned neural network based on the label.

10. The method as in claim 1, wherein the task request requests that the partitioned neural network make an inference about sensor data included in the task request.

11. An apparatus, comprising:
a network interface to communicate with a computer network;
a processor coupled to the network interface and configured to execute one or more processes; and
a memory configured to store a process that is executed by the processor, the process when executed configured to:
determine a level of service for a task request for processing by a partitioned neural network executed across a plurality of devices;
identify performance characteristics of different processing paths across the partitioned neural network;
select, based on the level of service for the task request and the performance characteristics of the different processing paths, a particular path from among the different processing paths to process the task request; and
send the task request for processing by the partitioned neural network along the particular path.

12. The apparatus as in claim 11, wherein a first device in the plurality of devices executes a partition of the partitioned neural network and a second device in the plurality of devices executes a copy of that partition.

13. The apparatus as in claim 12, wherein the first device is located along the particular path and the second device is located along another path from among the different processing paths.

14. The apparatus as in claim 11, wherein the level of service is based on a type of request associated with the task request or a data type associated with the task request.

15. The apparatus as in claim 11, wherein the level of service is based on a requestor that issued the task request.

16. The apparatus as in claim 11, wherein the plurality of devices executes at least one multiplexer and demultiplexer that connect two or more partitions of the partitioned neural network.

17. The apparatus as in claim 11, wherein the performance characteristics are indicative of at least one of: path latencies of the different processing paths, latency metrics for the plurality of devices, or queue information for the plurality of devices.

18. The apparatus as in claim 11, wherein the apparatus sends the task request for processing by the partitioned neural network along the particular path by:
applying a label to the task request indicative of the level of service.

19. The apparatus as in claim 18, wherein a device from among the plurality of devices prioritizes the task request for processing by a partition of the partitioned neural network based on the label.

20. A tangible, non-transitory, computer-readable medium storing program instructions that cause a controller to execute a process comprising:
determining, by the controller, a level of service for a task request for processing by a partitioned neural network executed across a plurality of devices;
identifying, by the controller, performance characteristics of different processing paths across the partitioned neural network;
selecting, by the controller, a particular path from among the different processing paths to process the task request, based on the level of service for the task request and the performance characteristics of the different processing paths; and
sending, by the controller, the task request for processing by the partitioned neural network along the particular path.
